(19) United States
(12) Patent Application Publication
(10) Pub. No.: US 2008/0286612 A1
(43) Pub. Date: Nov. 20, 2008

(54) Tunneling magnetic sensing element including Pt sublayer disposed between free magnetic sublayer and enhancing sublayer and method for producing tunneling magnetic sensing element

(75) Inventors: Masahiko Ishizone, Niigata-ken (JP); Masamichi Saito, Niigata-ken (JP); Kazumasa Nishimura, Niigata-ken (JP); Yosuke Ide, Niigata-ken (JP); Ryo Nakabayashi, Niigata-ken (JP); Naoya Hasegawa, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/890,081

(22) Filed: Aug. 3, 2007

(30) Foreign Application Priority Data
Sep. 13, 2006 (JP) 2006-247958

(51) Int. Cl. G11B 33/00; B05D 3/00; B05D 5/00

(52) U.S. Cl. 428/800; 427/131; 427/130

(57) ABSTRACT

There is provided a tunneling magnetic sensing element having an insulating barrier layer composed of Ti—O, a high rate of resistance change (ΔR/R) compared with the known art, and an interlayer coupling magnetic field Hin lower than that in the known art while low RA is maintained and the coercivity of a free magnetic layer is maintained at a low level comparable to the known art; and a method for producing the tunneling magnetic sensing element. An insulating barrier layer is composed of Ti—O. A free magnetic layer is formed on the insulating barrier layer and has a laminated structure of an enhancing sublayer composed of a CoFe alloy, a Pt sublayer, and a soft magnetic sublayer composed of a NiFe alloy, stacked in that order from the bottom.

### CLAIM OF PRIORITY

This application claims benefit of the Japanese Patent Application No. 2006-247958 filed on Sep. 13, 2006, which is hereby incorporated by reference.

### BACKGROUND

1. Field of the Invention

The present disclosure relates to tunneling magnetic sensing elements mounted on, for example, hard disk drives or used as magnetoresistive random-access memory (MRAM). In particular, the present disclosure relates to a tunneling magnetic sensing element having an insulating barrier layer composed of Ti—O, a high rate of resistance change (ΔR/R) compared with the known art, and an interlayer coupling magnetic field Hin lower than that in the known art while low RA is maintained and the coercivity of a free magnetic layer is maintained at a low level comparable to the known art. The present disclosure also relates to a method for producing the tunneling magnetic sensing element.

2. Description of the Related Art

Tunneling magnetic sensing elements (tunneling magnetoresistive (TMR) elements) change their resistance utilizing the tunneling effect. When the magnetization direction of a pinned magnetic layer is antiparallel to that of a free magnetic layer, a tunneling current does not easily flow through an insulating barrier layer (tunnel barrier layer) disposed between the pinned magnetic layer and the free magnetic layer. As a result, the resistance is maximized. On the other hand, when the magnetization direction of the pinned magnetic layer is parallel to that of the free magnetic layer, the tunneling current flows easily. As a result, the resistance is minimized.

A change in electrical resistance due to a change in the magnetization of the free magnetic layer affected by an external magnetic field is detected as a change in voltage on the basis of this principle to detect a leakage field from a recording medium.

Changing the material of the insulating barrier layer changes characteristics, such as the rate of resistance change (ΔR/R). Thus, studies have been conducted to different materials for the insulating barrier layer.

Important characteristics of a tunneling magnetic sensing element are: rate of resistance change (ΔR/R); RA (element resistance R×area A); the coercivity Hc of the free magnetic layer; an interlayer coupling magnetic field (Hin) acting between the free magnetic layer and the pinned magnetic layer; and the like. For the purpose of optimizing the characteristics, improvements of materials and layer structures of the insulating barrier layer and the pinned magnetic layer and the free magnetic layer formed on the top and bottom of the insulating barrier layer are being conducted. Japanese Unexamined Patent Application Publication Nos. 2000-215414 (Patent Document 1) and 2002-204010 (Patent Document 2) disclose examples of related art.

It is well known that aluminum oxide (Al—O) may be used as a material for the insulating barrier layer. In the case where the insulating barrier layer is composed of Al—O, the formation of the insulating barrier layer having a larger thickness appropriately exerts the tunneling effect, thereby improving the rate of resistance change (ΔR/R). In this case, however, RA is disadvantageously increased.

The increase in RA causes improper high-speed data transfer and cannot appropriately respond to an increase in recording density. Thus, RA must be minimized.

To reduce RA, for example, the thickness of the insulating barrier layer may be reduced. In the case where the insulating barrier layer is composed of Al—O, a reduction in the thickness of the insulating barrier layer rapidly reduces the rate of resistance change (ΔR/R).

On the other hand, in the case where the insulating barrier layer is composed of titanium oxide (Ti—O), even at a small thickness, the reduction in the rate of resistance change (ΔR/R) can be suppressed compared with the case of Al—O. Thus, at a lower RA range, it is possible to obtain the rate of resistance change (ΔR/R) higher than that of the insulating barrier layer composed of Al—O.

Although the insulating barrier layer composed of Ti—O can appropriately improve RA, the level of the rate of resistance change (ΔR/R) is not satisfactory.

To improve the rate of resistance change (ΔR/R) in a tunneling magnetic sensing element that includes an insulating barrier layer composed of Ti—O, for example, the free magnetic layer may include an enhancing sublayer on the side of the interface between the free magnetic layer and the insulating barrier layer. The enhancing sublayer may be composed of a CoFe alloy having high spin polarizability. In this case, the CoFe alloy having a Co composition ratio of, for example, 50 at % or more (Fe composition ratio of 50 at % or less) has higher spin polarizability, thus effectively providing a higher rate of resistance change (ΔR/R).

Although a high rate of resistance change (ΔR/R) can be obtained, the coercivity Hc and the interlayer coupling magnetic field Hin are disadvantageously increased. The increase in interlayer coupling magnetic field Hin increases the asymmetry of a waveform when the element functions as a magnetic head. Therefore, it is important to reduce the interlayer coupling magnetic field Hin.

None of the known structures described above satisfies a high rate of resistance change (ΔR/R), low coercivity Hc of the free magnetic layer, and a low interlayer coupling magnetic field Hin when the insulating barrier layer is composed of Ti—O.

Although Japanese Unexamined Patent Application Publication Nos. 2000-215414 and 2002-204010 each disclose a tunneling magnetic sensing element, the insulating barrier layer is not composed of Ti—O. As described above, the characteristics, such as the rate of resistance change (ΔR/R), depend on the material used for the insulating barrier layer. Thus, in the structures described in Japanese Unexamined Patent Application Publication Nos. 2000-215414 and 2002-20401, there is no recognition of the above-described problems where the insulating barrier layer is composed of Ti—O. Hence, no structure for improving the characteristics of the rate of resistance change (ΔR/R), coercivity Hc, and the interlayer coupling magnetic field Hin is disclosed.

Japanese Unexamined Patent Application Publication No. 2000-215414 does not disclose the material of the insulating barrier layer in the tunneling magnetic sensing element. This document discloses the free magnetic layer having a structure of NiFe/interface controlling sublayer/CoFe. Only an experiment using the interface controlling sublayer composed of Cu is conducted (see paragraph No. [0053] and subsequent paragraphs in Patent Document 1).

In the structure described in Japanese Unexamined Patent Application Publication No. 2002-20401, an experiment with a laminated structure of Al₂O₃/CoFe/Ru/NiFe is conducted (for example, see paragraph No. [0258] in Patent Document 2). No experiment using the insulating barrier layer composed of Ti—O is conducted.

### SUMMARY

To overcome the above-described known problems, the present disclosure relates to a tunneling magnetic sensing element having an insulating barrier layer composed of Ti—O. The present disclosure provides the tunneling magnetic sensing element having a high rate of resistance change (ΔR/R) compared with the known art and an interlayer coupling magnetic field Hin lower than that in the known art while low RA is maintained and the coercivity of a free magnetic layer is maintained at a low level comparable to the known art. In addition, the present disclosure provides a method for producing the tunneling magnetic sensing element.

The tunneling magnetic sensing element according to the present disclosure includes a first magnetic layer; an insulating barrier layer; and a second magnetic layer, disposed in that order from the bottom. One of the first magnetic layer and the second magnetic layer functions as a pinned magnetic layer, the magnetization direction of the pinned magnetic layer being pinned. The other of the first magnetic layer and the second magnetic layer functions as a free magnetic layer, and the magnetization direction of the free magnetic layer changes in response to an external magnetic field. The insulating barrier layer is composed of Ti—O. The free magnetic layer includes a soft magnetic sublayer containing at least Ni, and an enhancing sublayer disposed between the soft magnetic sublayer and the insulating barrier layer, the enhancing sublayer having spin polarizability larger than that of the soft magnetic sublayer A Pt sublayer is disposed between the soft magnetic sublayer and the enhancing sublayer.

According to the present disclosure, in a tunneling magnetic sensing element that includes an insulating barrier layer composed of Ti—O, it is possible to obtain a higher rate of resistance change (ΔR/R) compared with the known art while low RA is maintained. Furthermore, the coercivity of the free magnetic layer is maintained at a low level comparable to the known art. The interlayer coupling magnetic field (Hin) acting between the free magnetic layer and the pinned magnetic layer is reduced compared with the known art.

In an embodiment of the present disclosure, the Pt sublayer preferably has a thickness of about 2 Å to about 10 Å. In this case, the results of experiments described below demonstrate that the rate of resistance change (ΔR/R) is appropriately improved compared with the known art (a structure without the Pt sublayer) and that the interlayer coupling magnetic field Hin is reduced compared with the known art while coercivity is maintained at a low level comparable to the known art.

In another embodiment of the present disclosure, preferably, the enhancing sublayer is composed of Co_{X}Fe_{100-X}, and a Co composition ratio X is in the range from about 5 at % and less than about 50 at %. This increases the rate of resistance change (ΔR/R) and suppresses an increase in the coercivity Hc of the free magnetic layer.

In another embodiment of the present disclosure, preferably, at least part of the enhancing sublayer has a body-centered cubic structure. This appropriately suppresses the increase in the coercivity Hc of the free magnetic layer.

In another embodiment of the present disclosure, preferably, the soft magnetic sublayer is composed of Ni_{Y}Fe_{100-Y}, and a Ni composition ratio Y is in the range of about 81.5 at % to about 100 at %. This improves the soft magnetic characteristics of the free magnetic layer.

In the present disclosure, the interdiffusion of a constituent element may occur between the Pt sublayer and the enhancing sublayer and between the Pt sublayer and the soft magnetic sublayer, and a concentration gradient in which a Pt concentration is gradually reduced from the inside of the Pt sublayer toward the inside of the enhancing sublayer and toward the inside of the soft magnetic sublayer may be generated.

In another embodiment of the present disclosure, preferably, the first magnetic layer is the pinned magnetic layer, and the second magnetic layer is the free magnetic layer.

A method is disclosed for producing a tunneling magnetic sensing element including a first magnetic layer; an insulating barrier layer; and a second magnetic layer, disposed in that order from the bottom, one of the first magnetic layer and the second magnetic layer functioning as a pinned magnetic layer, the magnetization direction of the pinned magnetic layer being pinned, the other functioning as a free magnetic layer, the magnetization direction of the free magnetic layer changing in response to an external magnetic field, and the free magnetic layer including a soft magnetic sublayer containing at least Ni; and an enhancing sublayer disposed between the soft magnetic sublayer and the insulating barrier layer, the enhancing sublayer having spin polarizability larger than that of the soft magnetic sublayer. In the method the first magnetic layer is formed. The insulating barrier layer is formed on the first magnetic layer, the insulating barrier layer being composed of Ti—O. The second magnetic layer is formed on the insulating barrier layer. A Pt sublayer is formed so as to be arranged between the soft magnetic sublayer and the enhancing sublayer.

By employing the disclosed method, it is possible to simply and appropriately produce a tunneling magnetic sensing element having a high rate of resistance change (ΔR/R) compared with the known art and a low interlayer coupling magnetic field Hin acting between the free magnetic layer and the pinned magnetic layer compared with the known art while low RA is maintained and the coercivity of the free magnetic layer is maintained at a low level comparable to the known art.

In one embodiment of the present disclosure, preferably, the Pt sublayer is formed so as to have a thickness of about 2 Å to about 10 Å. This appropriately improves the rate of resistance change (ΔR/R) compared with the known art and reduces the interlayer coupling magnetic field Hin compared with the known art while the coercivity is maintained at a low level comparable to the known art.

In another embodiment, preferably, the enhancing sublayer is formed so as to be composed of Co_{X}Fe_{100-X}, and a Co composition ratio X is in the range from about 5 at % and less than about 50 at %. This suppresses an increase in the coercivity Hc of the free magnetic layer while the rate of resistance change (ΔR/R) is increased.

In another embodiment, preferably, the soft magnetic sublayer is formed so as to be composed of Ni_{Y}Fe_{100-Y}, and a Ni composition ratio Y is in the range of about 81.5 at % to about 100 at %.

In another embodiment, preferably, the first magnetic layer is formed of the pinned magnetic layer, and the second magnetic layer is formed of the free magnetic layer, and in the step (c), the Pt sublayer described in the step (d) is formed on the enhancing sublayer arranged on the insulating barrier layer, and the soft magnetic sublayer is formed on the Pt sublayer.

In another embodiment, preferably, annealing is performed after forming the second magnetic layer.

In the present disclosure, the tunneling magnetic sensing element including the insulating barrier layer composed of Ti—O has a high rate of resistance change (ΔR/R) compared with the known art while low RA is maintained. Furthermore, the tunneling magnetic sensing element has the coercivity of a free magnetic layer is maintained at a low level comparable to the known art. In addition, the tunneling magnetic sensing element has a low interlayer coupling magnetic field Hin acting between the free magnetic layer and the pinned magnetic layer, compared with the known art.

### BRIEF DESCRIPTION OF THE DRAWINGS

FIG. 1 is a cross-sectional view of a tunneling magnetic sensing element according to an embodiment, the view being taken along a plane parallel to a face facing a recording medium;

FIG. 2 is a fragmentary enlarged cross-sectional view of a structure of a free magnetic layer according to an embodiment and shows a graph of the compositional modulation of Pt;

FIG. 3 is a process drawing of a method for producing a tunneling magnetic sensing element according to an embodiment (cross-sectional view of the tunneling magnetic sensing element during the production process, the view being taken along a plane parallel to a face facing a recording medium);

FIG. 4 is a process drawing showing a step subsequent to the step shown in FIG. 3 (cross-sectional view of the tunneling magnetic sensing element during the production process, the view being taken along a plane parallel to a face facing a recording medium);

FIG. 5 is a process drawing showing a step subsequent to the step shown in FIG. 4 (cross-sectional view of the tunneling magnetic sensing element during the production process, the view being taken along a plane parallel to a face facing a recording medium);

FIG. 6 is a process drawing showing a step subsequent to the step shown in FIG. 5 (cross-sectional view of the tunneling magnetic sensing element during the production process, the view being taken along a plane parallel to a face facing a recording medium);

FIG. 7 is a graph showing the relationship between the rate of resistance change (ΔR/R) and the thickness of a Pt sublayer disposed between a soft magnetic sublayer (NiFe) and an enhancing sublayer (CoFe);

FIG. 8 is a graph showing the relationship between the coercivity Hc of the free magnetic layer and the thickness of the Pt sublayer disposed between the soft magnetic sublayer (NiFe) and the enhancing sublayer (CoFe);

FIG. 9 is a graph showing the relationship between the interlayer coupling magnetic field Hin and the thickness of the Pt sublayer disposed between the soft magnetic sublayer (NiFe) and the enhancing sublayer (CoFe); and

FIG. 10 is a graph showing the relationship between the rate of resistance change (ΔR/R) and an insertion sublayer disposed between the soft magnetic sublayer (NiFe) and the enhancing sublayer (CoFe) when the insertion sublayer is the Pt sublayer and a Ru sublayer.

### DESCRIPTION OF THE PREFERRED EMBODIMENTS

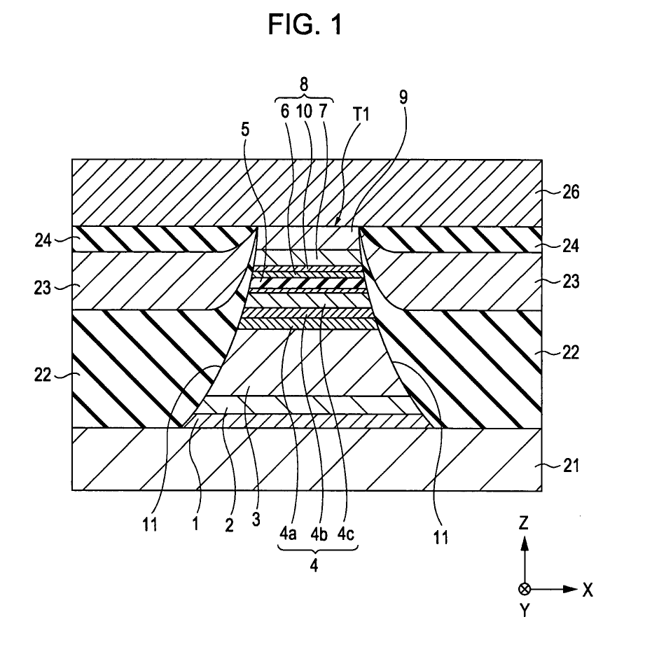

FIG. 1 is a cross-sectional view of a tunneling magnetic sensing element (tunneling magnetoresistive elements) according to an embodiment, the view being taken along a plane parallel to a face facing a recording medium

The tunneling magnetic sensing element is mounted on a trailing end of a floating slider included in a hard disk drive and detects a recording magnetic field from a hard disk or the like. In each drawing, the X direction indicates a track width direction. The Y direction indicates the direction of a magnetic leakage field from a magnetic recording medium (height direction). The Z direction indicates the direction of motion of a magnetic recording medium such as a hard disk and also indicates the stacking direction of layers in the tunneling magnetic sensing element.

In FIG. 1, the lowermost layer is a bottom shield layer 21 composed of, for example, a Ni—Fe alloy. A laminate T1 is arranged on the bottom shield layer 21. The tunneling magnetic sensing element includes the laminate T1, lower insulating layers 22, hard bias layers 23, and upper insulating layers 24 arranged on both sides of the laminate T1 in the track width direction (X direction in the figure).

The lowermost layer of the laminate T1 is an underlying layer 1 composed of at least one nonmagnetic element selected from Ta, Hf, Nb, Zr, Ti, Mo, and W. The underlying layer 1 is overlaid with a seed layer 2. The seed layer 2 is composed of NiFeCr or Cr. The seed layer 2 composed of NiFeCr has a face-centered cubic (fcc) structure. In this case, equivalent crystal planes each expressed as the {111} plane are dominantly oriented in the direction parallel to the surface of the seed layer. Alternatively, the seed layer 2 composed of Cr has a body-centered cubic (bcc) structure. In this case, equivalent crystal planes each expressed as the {110} plane are dominantly oriented in the direction parallel to the surface of the seed layer. Note that the underlying layer 1 does not need to be formed.

The seed layer 2 is overlaid with an antiferromagnetic layer 3. The antiferromagnetic layer 3 is preferably composed of an antiferromagnetic material containing an element X and Mn, the element X being at least one element selected from Pt, Pd, Ir, Rh, Ru, and Os.

The X—Mn alloy containing the element of the platinum group has excellent characteristics as an antiferromagnetic material, e.g., satisfactory corrosion resistance, a high blocking temperature, and a high exchange coupling magnetic field (Hex).

Alternatively, the antiferromagnetic layer 3 may be composed of an antiferromagnetic material containing the element X, an element X′, and Mn, the element XI being at least one element selected from Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb and rare-earth elements.

The antiferromagnetic layer 3 is overlaid with a pinned magnetic layer 4 corresponding to a “first magnetic layer” according to this embodiment. The pinned magnetic layer 4 has a multilayered ferrimagnetic structure including a first pinned magnetic sublayer 4a, a nonmagnetic intermediate sublayer 4b, and a second pinned magnetic sublayer 4c, formed in that order from the bottom. The magnetization direction of the first pinned magnetic sublayer 4a is antiparallel to that of the second pinned magnetic sublayer 4c because of an exchange coupling magnetic field at the interface between the antiferromagnetic layer 3 and the pinned magnetic layer 4 and an antiferromagnetic exchange coupling magnetic field (RKKY interaction) via the nonmagnetic intermediate sublayer 4b. This is referred to as a “multilayered ferrimagnetic structure”. This structure can stabilize the magnetization of the pinned magnetic layer 4 and can apparently increase the exchange coupling magnetic field generated at the interface between the pinned magnetic layer 4 and the antiferromagnetic layer 3. The first pinned magnetic sublayer 4a and the second pinned magnetic sublayer 4c each have a thickness of about 12 to about 40 Å. The nonmagnetic intermediate sublayer 4b has a thickness of about 8 to about 10 Å.

The first pinned magnetic sublayer 4a and the second pinned magnetic sublayer 4c are each composed of a ferromagnetic material, for example, CoFe, NiFe, or CoFeNi. The nonmagnetic intermediate sublayer 4b is composed of a nonmagnetic conductive material, for example, Ru, Rh, Ir, Cr, Re, or Cu.

The pinned magnetic layer 4 is overlaid with an insulating barrier layer 5. The insulating barrier layer 5 is composed of titanium oxide (Ti—O). The insulating barrier layer 5 may be formed by sputtering with a target composed of Ti—O. Preferably, the insulating barrier layer 5 is formed by forming a Ti layer having a thickness of about 1 to about 10 Å and then oxidizing the Ti layer to form a Ti—O layer. In this case, although the thickness is increased by oxidation, the insulating barrier layer 5 preferably has a thickness of about 1 to about 20 Å. An excessively larger thickness of the insulating barrier layer 5 is not preferred because a tunneling current does not easily flow to reduce output even in a state in which a tunneling current will flow most easily, i.e., the magnetization direction of the second pinned magnetic sublayer 4c is parallel to that of a free magnetic layer 8,

The insulating barrier layer 5 is overlaid with the free magnetic layer 8 corresponding to a “second magnetic layer” according to this embodiment. The free magnetic layer 8 includes a soft magnetic sublayer 7 composed of a magnetic material such as a NiFe alloy; an enhancing sublayer 6 provided between the soft magnetic sublayer 7 and the insulating barrier layer 5 and composed of a CoFe alloy or the like; and a Pt sublayer 10 provided between the soft magnetic sublayer 7 and the enhancing sublayer 6. The soft magnetic sublayer 7 may be composed of NiFe, Ni, NiFeCo, or the like. In particular, preferably, the soft magnetic sublayer 7 is composed of Ni_{Y}Fe_{100-Y}, which is a material having excellent soft magnetic characteristics (e.g., low coercivity and low magnetostriction). A Ni composition ratio Y is preferably in the range of about 81.5 at % to about 100 at % and more preferably about 90 at % or less.

The enhancing sublayer 6 is composed of a magnetic material having spin polarizability larger than that of the soft magnetic sublayer 7. In this embodiment, preferably, the enhancing sublayer 6 is composed of Co_{X}Fe_{100-X}. A Co composition ratio X is preferably in the range from about 5 at % and less than about 50 at % and more preferably about 30 at % or less.

The enhancing sublayer 6 composed of the CoFe alloy having large spin polarizability improves the rate of resistance change (ΔR/R). An increase in Co content increases the coercivity Hc of the free magnetic layer 8 and the interlayer coupling magnetic field Hin acting between the free magnetic layer 8 and the pinned magnetic layer 4. Thus, in this embodiment, the content of Co is preferably set in the range from about 5 at % and less than about 50 at % as described above.

An excessively large thickness of the enhancing sublayer 6 adversely affects the magnetic detection sensitivity of the soft magnetic sublayer 7, leading to a reduction in detection sensitivity. Thus, the enhancing sublayer 6 is formed so as to have a thickness smaller than that of the soft magnetic sublayer 7. For example, the soft magnetic sublayer 7 is formed so as to have a thickness of about 30 to about 70 Å. The enhancing sublayer 6 is formed so as to have a thickness of about 10 Å. The enhancing sublayer 6 preferably has a thickness of about 6 to about 20 Å.

The Pt sublayer 10 arranged between the soft magnetic sublayer 7 and the enhancing sublayer 6 will be described in detail below.

A track width Tw is determined by the width of the free magnetic layer 8 in the track width direction (X direction in the figure).

The free magnetic layer 8 is overlaid with a protective layer 9 composed of a nonmagnetic material such as Ta.

As described above, the laminate T1 is provided on the bottom shield layer 21. Both end faces 11 and 11 of the laminate T1 in the track width direction (X direction in the figure) are inclined planes such that the width of the laminate T1 in the track width direction is gradually reduced with height.

As shown in FIG. 1, the lower insulating layers 22 are disposed on the bottom shield layer 21 that extends toward both sides of the laminate Ti and disposed on the end faces 11 and 11 of the laminate T1. The hard bias layers 23 are disposed on the lower insulating layers 22. The upper insulating layers 24 are disposed on the hard bias layers 23.

Bias underlying layers (not shown) may be disposed between the lower insulating layers 22 and the hard bias layers 23. The bias underlying layers are each composed of, for example, Cr, W, or Ti.

The lower and upper insulating layers 22 and 24 are each composed of an insulating material, such as Al₂O₃ or SiO₂. The lower and upper insulating layers 22 and 24 insulate the hard bias layers 23 in such a manner that a current flowing through the laminate T1 in the direction perpendicular to interfaces between the layers is not diverted to both sides of the laminate T1 in the track width direction. The hard bias layers 23 are each composed of, for example, a Co—Pt (cobalt-platinum) alloy or a Co—Cr—Pt (cobalt-chromium-platinum) alloy.

The laminate Ti and the upper insulating layers 24 are overlaid with a top shield layer 26 composed of, for example, a NiFe alloy.

In the embodiment shown in FIG. 1, the bottom shield layer 21 and the top shield layer 26 each function as an electrode layer. A current flows in the direction perpendicular to surfaces of the layers of the laminate T1 (in the direction parallel to the Z direction in the figure).

A bias magnetic field from the hard bias layers 23 is applied to the free magnetic layer 8 to magnetize the free magnetic layer 8 in the direction parallel to the track width direction (X direction in the figure). On the other hand, the first pinned magnetic sublayer 4a and the second pinned magnetic sublayer 4c constituting the pinned magnetic layer 4 are magnetized in the direction parallel to the height direction (Y direction in the figure). Since the pinned magnetic layer 4 has a multilayered ferrimagnetic structure, the magnetization direction of the first pinned magnetic sublayer 4a is antiparallel to that of the second pinned magnetic sublayer 4c. The magnetization of the pinned magnetic layer 4 is pinned, i.e., the magnetization is not changed by an external magnetic field. The magnetization of the free magnetic layer 8 varies in response to the external magnetic field.

In the case where the magnetization of the free magnetic layer 8 is changed by the external magnetic field, when the magnetization direction of the second pinned magnetic sublayer 4c is antiparallel to that of the free magnetic layer 8, a tunneling current does not easily flow through the insulating barrier layer 5 disposed between the second pinned magnetic sublayer 4c and the free magnetic layer 8 to maximize a resistance. On the other hand, when the magnetization direction of the second pinned magnetic sublayer 4c is parallel to that of the free magnetic layer 8, the tunneling current flows easily to minimize the resistance.

On the basis of this principle, a change in electric resistance due to a change in the magnetization of the free magnetic layer 8 affected by the external magnetic field is converted into a change in voltage to detect a leakage magnetic field from a magnetic recording medium.

Advantages of the tunneling magnetic sensing element according to this embodiment will be described below.

As shown in FIG. 1, in this embodiment, the Pt sublayer 10 is provided between the soft magnetic sublayer 7 and the enhancing sublayer 6. Experiments described below prove that the formation of the Pt sublayer 10 between the soft magnetic sublayer 7 and the enhancing sublayer 6 results in the tunneling magnetic sensing element including the insulating barrier layer 5 composed of Ti—O (titanium oxide) according to this embodiment and having a rate of resistance change (ΔR/R) higher than that in the known art, a low coercivity Hc of the free magnetic layer 8, and a low interlayer coupling magnetic field Hin while low RA is maintained. Specifically, RA can be set in the range of about 2 to 5 μm² and preferably about 2 to 3 Ωμm². The rate of resistance change (ΔR/R) can be set in the range of about 24% to 27%. The coercivity Hc of the free magnetic layer 8 can be set in the range of about 3 to 5 Oe (1 Oe is about 79 A/m). The interlayer coupling magnetic field Hin can be set in the range of about 12 to 16 Oe.

It is not known exactly why the rate of resistance change (ΔR/R) can be increased. As a possible cause, the Pt sublayer 10 prevents Ni atoms of the NiFe alloy constituting the soft magnetic sublayer 7 from diffusing in the insulating barrier layer 5 and the enhancing sublayer 6. That is, it is likely that the diffusion-preventing effect of the Pt sublayer 10 affects the increase. As demonstrated in the experiments described below, however, a structure in which Ru, which is an element of the platinum group including Pt, is provided between the soft magnetic sublayer 7 and the enhancing sublayer 6 (this structure of the free magnetic layer is the same as a structure described in paragraph No. [0258] in Patent Document 2) reduces the rate of resistance change (ΔR/R). Thus, it is likely that the structure including the insulating barrier layer 5 composed of Ti—O and the Pt sublayer 10 provided between the soft magnetic sublayer 7 and the enhancing sublayer 6 has another effect in addition to the diffusion-preventing effect, thereby increasing the rate of resistance change (ΔR/R).

In this embodiment, the coercivity Hc of the free magnetic layer 8 is substantially equal to that in a structure without the Pt sublayer 10, i.e., the structure in which the free magnetic layer 8 has a two-layer structure of the soft magnetic sublayer 7 and the enhancing sublayer 6. From the viewpoint of this, it is assumed that, for example, a CoPt alloy, which has high coercivity Hc, is negligibly formed by diffusion of the enhancing sublayer 6 composed of the CoFe alloy and the Pt sublayer 10. The CoPt alloy has a hexagonal close-packed (hcp) structure. In this embodiment, overall, the hcp structure is not formed. Also, the enhancing sublayer 6 does not have the hcp structure. At least part of the enhancing sublayer 6 composed of the CoFe alloy has a body-centered cubic (bcc) structure, thereby suppressing the increase in coercivity Hc.

In this embodiment, the enhancing sublayer 6 may be composed of a magnetic material, such as Co, other than the CoFe alloy. When the enhancing sublayer 6 is composed of Co_{X}Fe_{100-X}, a Co composition ratio X is set in the range from about 5 at % and less than about 50 at %. A higher Co composition ratio results in higher spin polarizability, thus possibly improving the rate of resistance change (ΔR/R) and increasing the coercivity Hc of the free magnetic layer 8. In this embodiment, the formation of the enhancing sublayer 6 having high spin polarizability improves the rate of resistance change (ΔR/R). In this case, the enhancing sublayer 6 is formed so as to have a composition capable of suppressing the increase in the coercivity Hc of the free magnetic layer 8, and the Pt sublayer 10 is formed between the enhancing sublayer 6 and the soft magnetic sublayer 7 in such a manner that a still insufficient rate of resistance change (ΔR/R) is improved.

In this embodiment, the interlayer coupling magnetic field Hin acting between the free magnetic layer 8 and the pinned magnetic layer 4 is smaller than that in the known art, thereby reducing asymmetry of a read waveform and improving the stability of reading characteristics compared with that in the known art.

The insulating barrier layer 5 composed of Ti—O has at least one of structures selected from a body-centered cubic (bcc) structure, a body-centered tetragonal structure, a rutile structure, and an amorphous structure. When the enhancing sublayer 6 is formed on the insulating barrier layer 5 composed of Ti—O so as to be composed of a CoFe alloy having a Co composition ratio in the range from about 5 at % and less than about 50 at %, the enhancing sublayer 6 suitably has a body-centered cubic structure.

Preferably, the Pt sublayer 10 has a thickness of about 2 Å to about 10 Å. An excessively large thickness of the Pt sublayer 10 is not preferred because of a reduction in the rate of resistance change (ΔR/R). In particular, when the Pt sublayer 10 has a thickness of about 4 to about 6 Å, a high rate of resistance change (ΔR/R) is reliably obtained.

It is speculated that the soft magnetic sublayer 7 is ferromagnetically coupled to the enhancing sublayer 6 via the Pt sublayer 10, and the magnetization direction of the soft magnetic sublayer 7 is the same as that of the enhancing sublayer 6.

The tunneling magnetic sensing element is subjected to annealing (heat treatment) during a production process. Annealing is performed at about 240° C. to about 310° C. This annealing is, for example, annealing in a magnetic field in order to generate an exchange coupling magnetic field (Hex) between the antiferromagnetic layer 3 and the first pinned magnetic sublayer 4a constituting the pinned magnetic layer 4.

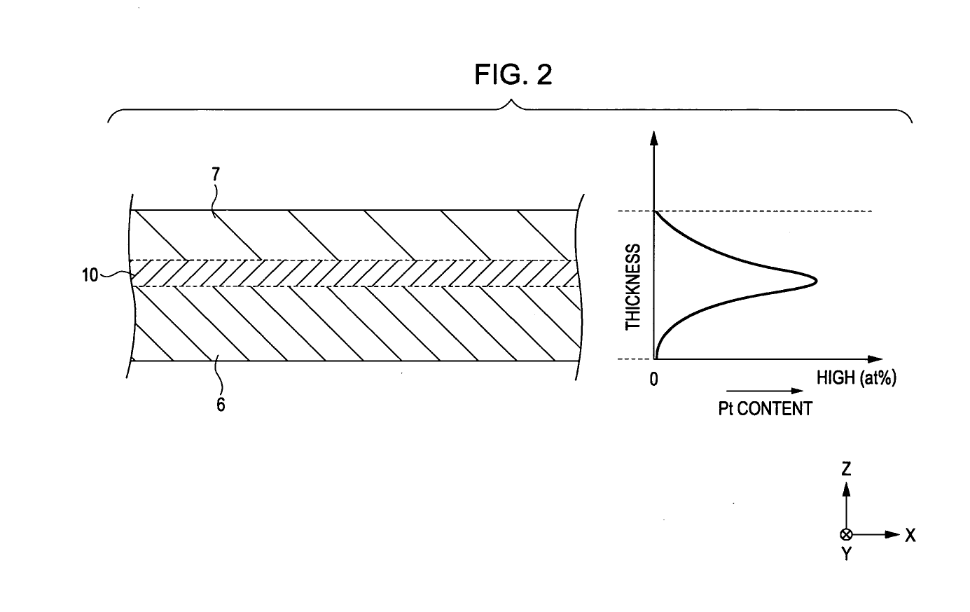

As shown in FIG. 2, the annealing results in the interdiffusion of constituent elements at interfaces between the Pt sublayer 10 and the soft magnetic sublayer 7 and between the Pt sublayer 10 and the enhancing sublayer 6, thereby eliminating the interfaces. A concentration gradient in which a Pt concentration is gradually reduced from the inside of the Pt sublayer 10, e.g., from the center of the Pt sublayer 10 in the thickness direction, toward the inside of the enhancing sublayer 6 and toward the inside of the soft magnetic sublayer 7 is generated.

The generation of the concentration gradient probably affects the crystal structure to contribute to the improvement of the rate of resistance change (ΔR/R).

However, as described above, the enhancing sublayer 6 is not completely transformed into the hcp structure by diffusion between the Pt sublayer 10 and the enhancing sublayer 6. At least part of the enhancing sublayer 6 maintains the body-centered cubic structure.

In this embodiment, the antiferromagnetic layer 3, the pinned magnetic layer 4 (first magnetic layer), the insulating barrier layer 5, and the free magnetic layer 8 (second magnetic layer) are stacked in that order from the bottom. Alternatively, the free magnetic layer 8 (first magnetic layer), the insulating barrier layer 5, the pinned magnetic layer 4 (second magnetic layer), and the antiferromagnetic layer 3 may be stacked in that order from the bottom.

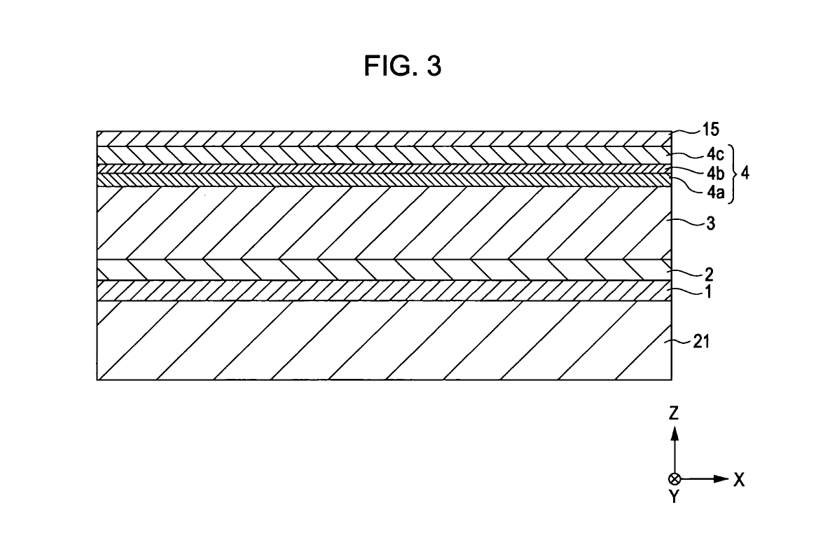

A method according to this embodiment for producing a tunneling magnetic sensing element will now be described. FIGS. 3 to 6 are each a fragmentary cross-sectional view of a tunneling magnetic sensing element during a production process, the view being taken along the same plane as in FIG. 1.

In a step shown in FIG. 3, the underlying layer 1, the seed layer 2, the antiferromagnetic layer 3, the first pinned magnetic sublayer 4a, the nonmagnetic intermediate sublayer 4b, and the second pinned magnetic sublayer 4c are successively formed on the bottom shield layer 21. Each of the layers is formed by, for example, sputtering.

The surface of the second pinned magnetic sublayer 4c is subjected to plasma treatment. The plasma treatment can effectively reduce the interlayer coupling magnetic field Hin acting between the pinned magnetic layer 4 and the free magnetic layer 8.

A Ti layer 15 is formed on the second pinned magnetic sublayer 4c by sputtering. The Ti layer 15 will be oxidized in the subsequent step. Thus, the Ti layer 15 is formed in such a manner that the thickness of the Ti layer 15 after oxidation is equal to the thickness of the insulating barrier layer 5.

An oxygen gas flows into a vacuum chamber. This oxidizes the Ti layer 15 to form the insulating barrier layer 5.

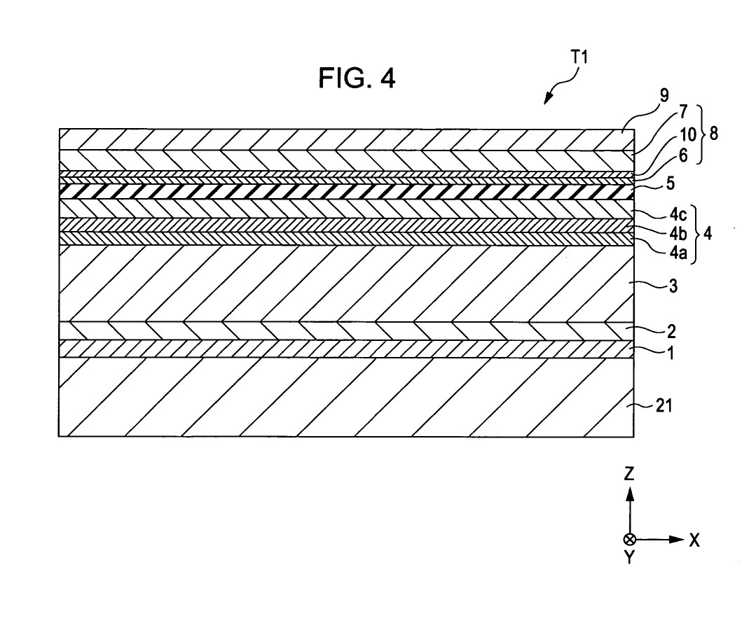

As shown in FIG. 4, the free magnetic layer 8 including the enhancing sublayer 6 composed of a CoFe alloy, the Pt sublayer 10, and the soft magnetic sublayer 7 composed of a NiFe alloy are formed on the insulating barrier layer 5 by sputtering. A protective layer 9 composed of, for example, Ta is formed on the free magnetic layer 8 by sputtering. Thereby, the laminate T1 including the underlying layer 1 to protective layer 9 stacked is formed.

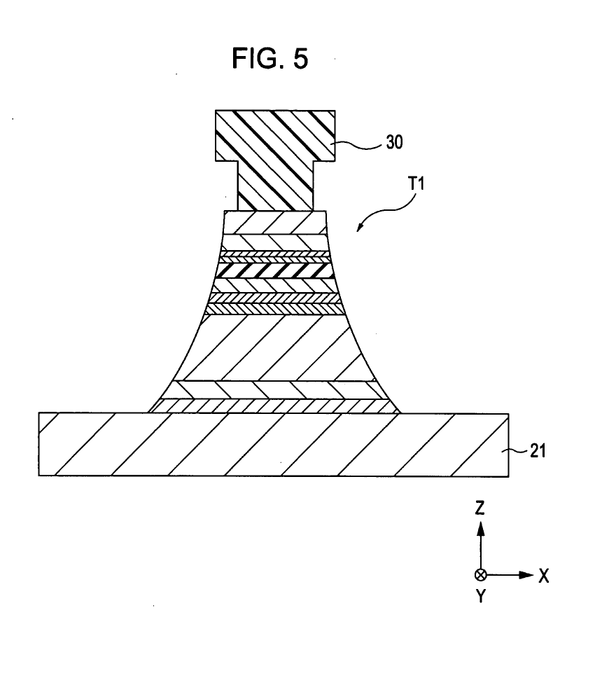

As shown in FIG. 5, a resist layer 30 used in a lift-off method is formed on the laminate T1. Both sides of the laminate T1 in the track width direction (X direction in the figure), which are not covered with the resist layer 30 are removed by etching or the like.

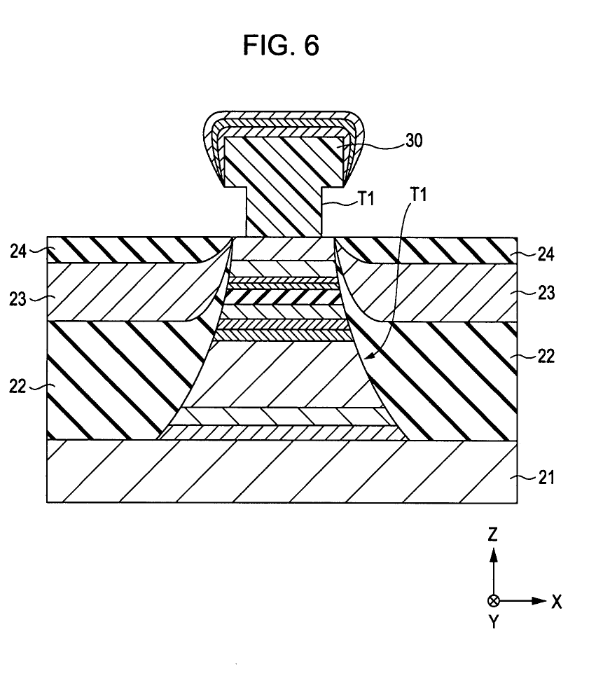

As shown in FIG. 6, the lower insulating layers 22, the hard bias layers 23, and the upper insulating layers 24 are stacked in that order from the bottom on both sides of the laminate T1 in the track width direction (X direction in the figure) and on the bottom shield layer 21.

The resist layer 30 is removed by the lift-off method. The top shield layer 26 is formed on the laminate T1 and the upper insulating layers 24.

The method for producing the tunneling magnetic sensing element includes annealing. An example of typical annealing is annealing in order to generate the exchange coupling magnetic field (Hex) between the antiferromagnetic layer 3 and the first pinned magnetic sublayer 4a.

During annealing, Pt element in the Pt sublayer 10 is diffused into the enhancing sublayer 6 and the soft magnetic sublayer 7. As a result, a concentration gradient in which a Pt concentration is gradually reduced from the center of the Pt sublayer 10 in the thickness direction toward the inside of the enhancing sublayer 6 and toward the inside of the soft magnetic sublayer 7 is generated.

In the case where the insulating barrier layer 5 is formed by oxidation of the Ti layer 15, examples of a method of oxidation include radical oxidation, ion oxidation, plasma oxidation, and natural oxidation.

In the method for producing the tunneling magnetic sensing element, the Pt sublayer 10 is provided between the enhancing sublayer 6 and the soft magnetic sublayer 7. This simply and appropriately produces a tunneling magnetic sensing element having a high rate of resistance change (ΔR/R) compared with the known art and a low interlayer coupling magnetic field Hin acting between the free magnetic layer 8 and the pinned magnetic layer 4 compared with the known art while low RA is maintained and the coercivity Hc of the free magnetic layer 8 is maintained at a low level comparable to the known art.

In this embodiment, the Pt sublayer 10 is formed so as to have a thickness of about 2 Å to about 10 Å. A thickness of the Pt sublayer 10 exceeding 10 Å results in a significant reduction in the rate of resistance change (ΔR/R). In this case, the rate of resistance change (ΔR/R) is easily reduced rather than the known art not including the Pt sublayer 10, degrading the effect of the presence of the Pt sublayer 10. A thickness of the Pt sublayer 10 of 2 Å or more results in the significant effect of improving the rate of resistance change (ΔR/R). Consequently, preferably, the Pt sublayer 10 is formed so as to have a thickness of about 2 Å to about 10 Å.

In this embodiment, the insulating barrier layer 5 and the free magnetic layer 8 are formed in such a manner that a structure of Ti—O/CoFe/Pt/NiFe is obtained, the layers being stacked in that order from the bottom. The rate of resistance change (ΔR/R) is probably improved by the suppression of diffusion of a Ni element constituting the soft magnetic sublayer 7 into the enhancing sublayer 6 (CoFe) and the insulating barrier layer 5 even when heat treatment is performed; and by another factor, in particular, another special effect attributed to the insulating barrier layer 5 composed of Ti—O and the Pt sublayer 10 provided between the soft magnetic sublayer 7 and the enhancing sublayer 6.

In this embodiment, the enhancing sublayer 6 is formed so as to be composed of CoFe having a Co composition ratio in the range from about 5 at % and less than about 50 at %, thereby improving the rate of resistance change (ΔR/R) and appropriately maintaining the coercivity Hc at a low level.

In the present invention, the soft magnetic sublayer 7 is formed so as to be composed of Ni_{Y}Fe_{100-Y}, and a Ni composition ratio Y is in the range of about 81.5 at % to about 100 at %. This improves the soft magnetic characteristics of the free magnetic layer 8. That is, a low coercivity Hc and low magnetostriction are obtained.

In this embodiment, the enhancing sublayer 6 is formed so as to have a body-centered cubic (bcc) structure. As described above, the interdiffusion of constituent elements is probably generated by heat treatment of the laminate T1 at predetermined conditions. In this case, however, at least part of the enhancing sublayer 6 maintains the body-centered cubic (bcc) structure, thereby suppressing the increase in the coercivity Hc of the free magnetic layer 8.

In this embodiment, the tunneling magnetic sensing element can be used not only in hard disk drives but also as magnetoresistive random-access memory (MRAM) and the like.

### Example

A tunneling magnetic sensing element shown in FIG. 1 was formed. In this experiment, a fundamental layer structure (laminate T1) was as follows: underlying layer 1; Ta (30)/a seed layer 2; NiFeCr (50)/antiferromagnetic layer 3; IrMn (70)/pinned magnetic layer 4 [first pinned magnetic sublayer 4a; Co_{70 at %}Fe_{30 at %} (14)/nonmagnetic intermediate sublayer 4b; Ru (9.1)/second pinned magnetic sublayer 4c; Co_{90 at %}Fe_{10 at %} (18)]/insulating barrier layer 5/free magnetic layer 8 [enhancing sublayer 6; Co_{10 at %}Fe_{90 at %} (10)/Pt (x)/soft magnetic sublayer 7; Ni_{86 at %}Fe_{14 at %} (50)]/protective layer [Ru (20)/Ta (180)], stacked in that order from the bottom. Each of the values in parentheses indicates an average thickness (unit: Å).

In each sample, the surface of the second pinned magnetic sublayer 4c was subjected to plasma treatment.

In each sample, after plasma treatment, a Ti layer having a thickness of 1 to 10 Å was formed on the second pinned magnetic sublayer 4c and oxidized to form the insulating barrier layer 5 composed of Ti—O.

The fundamental film structure was subjected to heat treatment at a temperature in the range of 240° C. to 300° C. for 4 hours.

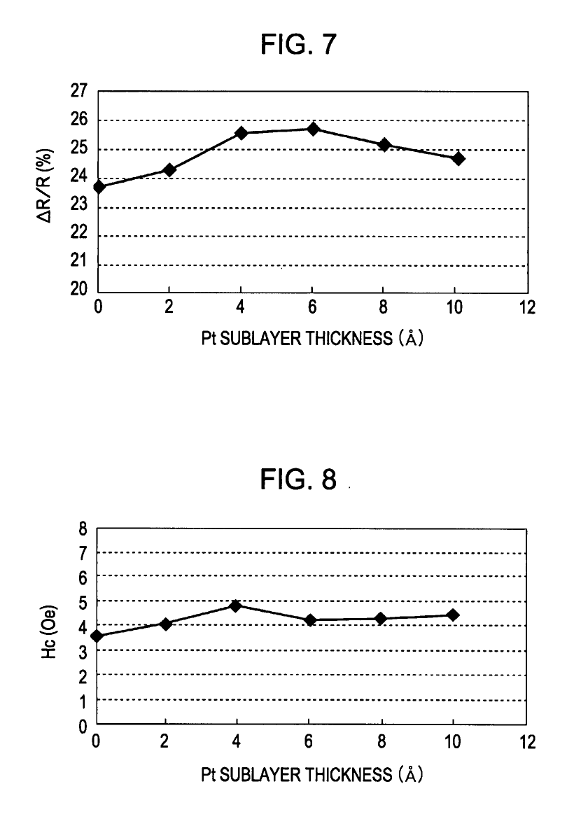

In this experiment, samples were made in such a manner that the Pt sublayers 10 each provided between the enhancing sublayer 6 and the soft magnetic sublayer 7 had thicknesses of 0 Å, 2 Å, 4 Å, 6 Å, 8 Å, and 10 Å. In each of the samples, the rate of resistance change (ΔR/R), the coercivity Hc of the free magnetic layer 8, and the interlayer coupling magnetic field Hin acting between the free magnetic layer 8 and pinned magnetic layer 4 were measured. The relationship between the thickness of the Pt sublayer 10 and the rate of resistance change (ΔR/R), the relationship between the thickness of the Pt sublayer 10 and the coercivity Hc of the free magnetic layer 8, and the relationship between the thickness of the Pt sublayer 10 and the interlayer coupling magnetic field Hin were determined. FIGS. 7 to 9 show the results. In each sample, RA (element resistance R×element area A) was in the range of 2 to 3 Ωμm².

As shown in FIG. 7, in the case where the Pt sublayer 10 was provided between the enhancing sublayer 6 and the soft magnetic sublayer 7 and where the Pt sublayer 10 had a thickness of 2 to 10 Å, the results demonstrated that the rate of resistance change (ΔR/R) was increased compared with the known art not including the Pt sublayer 10. In particular, the results demonstrated that a thickness of the Pt sublayer 10 of 4 to 6 Å resulted in a high, stable rate of resistance change (ΔR/R).

As shown in FIG. 8, the results demonstrated that when the thickness of the Pt sublayer 10 provided between the enhancing sublayer 6 and the soft magnetic sublayer 7 was in the range of 2 to 10 Å, the coercivity Hc of the free magnetic layer 8 was maintained at a low level comparable to the known art not including the Pt sublayer 10.

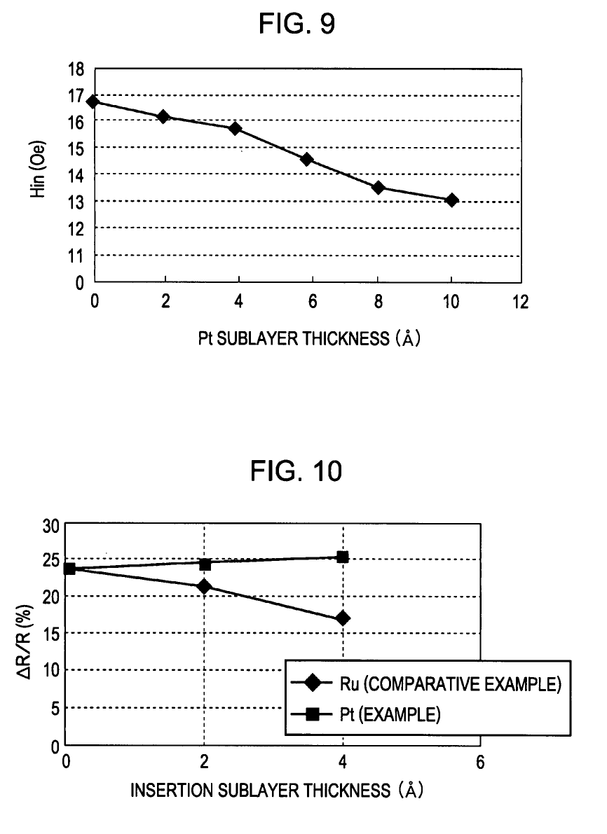

As shown in FIG. 9, the results demonstrated that when the thickness of the Pt sublayer 10 provided between the enhancing sublayer 6 and the soft magnetic sublayer 7 was in the range of 2 to 10 Å, the interlayer coupling magnetic field Hin was reduced compared with the known art not including the Pt sublayer 10.

As a comparative example, a structure in which the Pt sublayer of the fundamental layer structure was replaced with a Ru sublayer was formed. Plasma treatment and heat treatment conditions were the same as in the above-described experiment. With respect to each of the example in which the Pt sublayer was provided between the enhancing sublayer 6 and the soft magnetic sublayer 7 and the comparative example, the relationship between the rate of resistance change (ΔR/R) and the thickness of each of the Pt sublayer and the Ru sublayer was investigated. FIG. 10 shows the results.

As shown in FIG. 10, in the comparative example in which the Ru sublayer was provided, the results demonstrated that the rate of resistance change (ΔR/R) was lower than that in the known art not including the Ru sublayer, i.e., the known art in which the free magnetic layer 8 had a two-layer structure of the soft magnetic sublayer 7 and the enhancing sublayer 6. In contrast, in the example including the Pt sublayer, the results demonstrated that the rate of resistance change (ΔR/R) was higher than that in the known art.

What is claimed is:

1. A tunneling magnetic sensing element comprising:
a first magnetic layer;
an insulating barrier layer; and
a second magnetic layer, disposed in that order from the bottom, one of the first magnetic layer and the second magnetic layer functioning as a pinned magnetic layer, the magnetization direction of the pinned magnetic layer being pinned, the other functioning as a free magnetic layer, and the magnetization direction of the free magnetic layer changing in response to an external magnetic field,
wherein the insulating barrier layer is composed of Ti—O, the free magnetic layer includes
a soft magnetic sublayer containing at least Ni, and
an enhancing sublayer disposed between the soft magnetic sublayer and the insulating barrier layer, the enhancing sublayer having spin polarizability larger than that of the soft magnetic sublayer, and
wherein a Pt sublayer is disposed between the soft magnetic sublayer and the enhancing sublayer.

2. The tunneling magnetic sensing element according to claim 1, wherein the Pt sublayer has a thickness of about 2 Å to about 10 Å.

3. The tunneling magnetic sensing element according to claim 1, wherein the enhancing sublayer is composed of Co_{X}Fe_{100-X}, and a Co composition ratio X is in the range from about 5 at % and less than about 50 at %.

4. The tunneling magnetic sensing element according to claim 1, wherein at least part of the enhancing sublayer has a body-centered cubic structure.

5. The tunneling magnetic sensing element according to claim 1, wherein the soft magnetic sublayer is composed of Ni_{Y}Fe_{100-Y}, and a Ni composition ratio Y is in the range of about 81.5 at % to about 100 at %.

6. The tunneling magnetic sensing element according to claim 1, wherein the interdiffusion of a constituent element occurs between the Pt sublayer and the enhancing sublayer and between the Pt sublayer and the soft magnetic sublayer, and
wherein a concentration gradient in which a Pt concentration is gradually reduced from the inside of the Pt sublayer toward the inside of the enhancing sublayer and toward the inside of the soft magnetic sublayer is generated.

7. The tunneling magnetic sensing element according to claim 1, wherein the first magnetic layer is the pinned magnetic layer, and the second magnetic layer is the free magnetic layer.

8. A method for producing a tunneling magnetic sensing element including
a first magnetic layer;
an insulating barrier layer; and
a second magnetic layer, disposed in that order from the bottom, one of the first magnetic layer and the second magnetic layer functioning as a pinned magnetic layer, the magnetization direction of the pinned magnetic layer being pinned, the other functioning as a free magnetic layer, the magnetization direction of the free magnetic layer changing in response to an external magnetic field, and the free magnetic layer including
a soft magnetic sublayer containing at least Ni, and
an enhancing sublayer disposed between the soft magnetic sublayer and the insulating barrier layer, the enhancing sublayer having spin polarizability larger than that of the soft magnetic sublayer, the method comprising the steps of:
(a) forming the first magnetic layer;
(b) forming the insulating barrier layer on the first magnetic layer, the insulating barrier layer being composed of Ti—O;
(c) forming the second magnetic layer on the insulating barrier layer; and
(d) forming a Pt sublayer so as to be arranged between the soft magnetic sublayer and the enhancing sublayer.

9. The method for producing a tunneling magnetic sensing element according to claim 8, wherein the Pt sublayer is formed so as to have a thickness of about 2 Å to about 10 Å.

10. The method for producing a tunneling magnetic sensing element according to claim 8, wherein the enhancing sublayer is formed so as to be composed of Co_{X}Fe_{100-X}, and wherein a Co composition ratio X is in the range from about 5 at % and less than about 50 at %.

11. The method for producing a tunneling magnetic sensing element according to claim 8, wherein the soft magnetic sublayer is formed so as to be composed of Ni_{Y}Fe_{100-Y}, and wherein a Ni composition ratio Y is in the range of about 81.5 at % to about 100 at %.

12. The method for producing a tunneling magnetic sensing element according to claim 8, wherein the first magnetic layer is formed of the pinned magnetic layer, and the second magnetic layer is formed of the free magnetic layer, and
wherein in the step (c), the Pt sublayer described in the step (d) is formed on the enhancing sublayer arranged on the insulating barrier layer, and the soft magnetic sublayer is formed on the Pt sublayer.

13. The method for producing a tunneling magnetic sensing element according to claim 8, further comprising:
performing annealing after the step (c).
